(19) United States
(12) Patent Application Publication
(10) Pub. No.: US 2016/0346570 A1
(43) Pub. Date: Dec. 1, 2016

(54) SCAFFOLDING SAFETY LINE

(71) Applicants: Andrew Philip ANSON, Montreal (CA); Benjamin Buchanan ANSON, Beaconsfield (CA)

(72) Inventors: Andrew Philip ANSON, Montreal (CA); Benjamin Buchanan ANSON, Beaconsfield (CA)

(21) Appl. No.: 15/218,130

(22) Filed: Jul. 25, 2016

Related U.S. Application Data
(60) Provisional application No. 62/029,912, filed on Jul. 28, 2014.

(51) Int. Cl. A62B 35/00; E04G 5/00

(52) U.S. Cl. CPC A62B 35/005; A62B 35/0006; A62B 35/0037; E04G 5/001

(57) ABSTRACT

A scaffolding safety device is mountable to a scaffolding structure having a pair of spaced apart vertical structures and a platform horizontally extending therebetween for supporting a worker. The device comprises an elongate body, a pair of connectors and a safety line. The elongate body defines opposite longitudinal ends and each connector is positioned at or near a respective longitudinal end for being connected to a respective one of the spaced apart vertical structures thereby providing the elongate body to be horizontally disposed between the spaced apart vertical structures. The safety line comprises resilient material mounted at each longitudinal end thereof to or near a respective one of the longitudinal ends of the elongated body for horizontally and slackingly extending along a least a portion of the longitudinal length of the elongated body. The safety line provides for connecting a safety harness worn by the worker thereto. During accidental fall of the worker from the platform, the safety line provides for absorbing a force from the worker's weight via the harness.

### CROSS-REFERENCE TO RELATED APPLICATIONS

The present application claims priority on U.S. Provisional Patent Application No. 62/029,912 which was filed on Jul. 26, 2015 and which is incorporated herein by reference in its entirety.

### TECHNICAL FIELD

The present disclosure relates to scaffolding. More specifically, but not exclusively the present disclosure relates to a scaffolding safety line.

### BACKGROUND

Scaffolding is a temporary structure used to support workers and material in the construction or repair of buildings and other structures. The basic elements of a scaffold are standards, ledgers and transoms. The standards, also called uprights, are the vertical tubes and they rest on a square base plate. The base plate has a shank in its center to hold the tube and is sometimes pinned to a sole board. Ledgers are horizontal tubes which connect between the standards. Transoms rest upon the ledgers at right angles.

In order to avoid fatal accidents, workers use safety harnesses anchored to the scaffolding which in the event of a fall prevent the worker from fatally impacting the ground. Nevertheless and even when the harness provides some elasticity, the worker may still suffer injuries since the harness is rigidly anchored to the scaffold causing a rigidly abrupt break in their fall. Moreover, due to harness being fixed to a given anchor point on one of the scaffold elements or members, the worker's fall may cause a sudden strain on that given anchor point and bring down the scaffold member thereby potentially fatally injuring the worker.

### OBJECTS

It is an object of the present disclosure to provide a scaffolding safety device for being mounted to a scaffolding structure.

It is an object of the present disclosure to provide a scaffolding safety kit for being mounted to a scaffolding structure.

It is an object of the present disclosure to provide a scaffolding structure assembly.

It is an object of the present disclosure to provide a scaffolding structure.

It is an object of the present disclosure to provide a method of providing a scaffolding structure.

### SUMMARY

In accordance with an aspect of the present disclosure, there is provided a scaffolding safety device for being mounted to a scaffolding structure having a pair of spaced apart vertical structures and a platform horizontally extending therebetween for supporting a worker, the device comprising: an elongate body defining opposite longitudinal ends; a pair of connectors, each connector positioned at or near a respective longitudinal end for being connected to a respective one of the spaced apart vertical structures thereby providing the elongate body to be horizontally disposed between the spaced apart vertical structures; a safety line comprising resilient material mounted at each longitudinal end thereof to or near a respective one of the longitudinal ends of the elongated body for horizontally and slackingly extending along a least a portion of the longitudinal length of the elongated body, the safety line providing for connecting a safety harness worn by the worker thereto, wherein during accidental fall of the worker from the platform, the safety line provides for absorbing a force from the worker's weight via the harness.

In an embodiment, each of the connectors is clamped to a portion of a respective one of the spaced apart vertical structures. In an embodiment, each of the connectors is rotatable so as for being selectively positioned on a given portion of the vertical structure.

In an embodiment, the safety line comprises a wire. In an embodiment, the safety line comprises a wire anchored at each end to the elongate body. In an embodiment, the safety line comprises at least one loop mounted thereto for being connected to the safety harness.

In an embodiment, the horizontal length of the elongate body is selectively adjustable.

In an embodiment, the safety line comprises at least one loop mounted thereto for being connected to the safety harness. In an embodiment, the safety harness is connectable to the safety line via a lanyard connectable thereto. In an embodiment, lanyard is connectable to the safety line via vertical line connectable thereto.

In accordance with an aspect of the present disclosure, there is provided a scaffolding safety kit for being mounted to a scaffolding structure having a pair of spaced apart vertical structures and a platform horizontally extending therebetween for supporting a worker, the kit comprising: an elongate body defining opposite longitudinal ends; a pair of connectors for being positioned at or near a respective longitudinal end for being connected to a respective one of the spaced apart vertical structures thereby providing the elongate body to be horizontally disposed between the spaced apart vertical structures; a safety line comprising resilient material for being mounted at each longitudinal end thereof to or near a respective one of the longitudinal ends of the elongated body for horizontally and slackingly extending along a least a portion of the longitudinal length of the elongated body, the safety line providing for connecting a safety harness worn by the worker thereto, wherein during accidental fall of the worker from the platform, the safety line provides for absorbing a force from the worker's weight via the harness.

In an embodiment, the kit further comprises the safety harness. In an embodiment, the kit further comprises a lanyard for being connected to the safety harness and the safety line. In an embodiment, the kit further comprises a vertical safety line for being connected to the safety harness and the safety line.

In accordance with an aspect of the present disclosure, there is provided a scaffolding structure assembly comprising: at least a pair of spaced apart vertical structures; at least one platform for being mounted at each end thereof to a respective one spaced apart vertical structures thereby horizontally extending therebetween for supporting a worker; and the scaffolding safety device as described herein.

In an embodiment, the scaffolding structure assembly further comprises a rear support for interconnecting the spaced apart vertical structures. In an embodiment, a front support for interconnecting the spaced apart vertical structures. In an embodiment, a vertical line for being suspended from the safety line.

In accordance with an aspect of the present disclosure, there is provided a scaffolding structure comprising: at least a pair of spaced apart vertical structures; at least one platform mounted at each end thereof to a respective one of the spaced apart vertical structures thereby horizontally extending therebetween for supporting a worker; and the scaffolding safety device as described herein.

In an embodiment, the spaced apart vertical structures are interconnected by a support selected from the group consisting of: a front support, a rear support and a combination thereof.

In accordance with an aspect of the present disclosure, there is provided a method of providing a scaffolding structure comprising: providing at least a pair of spaced apart vertical structures; mounting at least one platform at each end thereof to a respective one of the spaced apart vertical structures thereby horizontally extending therebetween for supporting a worker; and mounting the scaffolding safety device as described herein to the pair of spaced apart vertical structures.

In accordance with an aspect of the present disclosure, there is provided a scaffolding structure comprising: at least a pair of spaced apart vertical structures upstanding from respective bases; at least one horizontal member mounted at each horizontal end thereof to a respective one of the pair of vertical structures; and a safety line comprising resilient material mounted at each longitudinal end thereof to a respective one of the horizontal ends of the horizontal member and slackly hanging between the ends thereof, wherein the safety line provides for connecting a safety harness worn by a worker thereto.

In accordance with an aspect of the present disclosure, there is provided a safety line assembly for a scaffolding structure comprising at least a pair of spaced apart vertical structures upstanding from respective bases and at least one horizontal member mounted at each horizontal end thereof to a respective one of the pair of vertical structures, the safety line assembly comprising: a safety line comprising resilient material and defining longitudinal ends thereof; a pair of connectors for being respectively mounted to a respective one of the horizontal ends of the horizontal member, the safety line being mounted at each longitudinal end thereof to a respective one of the pair of connectors so as to slackly hang between the longitudinal ends thereof when the connectors are mounted to the horizontal ends of the horizontal member, wherein the safety line provides for connecting a safety harness worn by a worker thereto.

In accordance with an aspect of the present disclosure, there is provided a safety line assembly for a scaffolding structure comprising at least a pair of spaced apart vertical structures upstanding from respective bases, the safety line assembly comprising: a horizontal member for being mounted at each horizontal end thereof to a respective one of the pair of vertical structures; a safety line comprising resilient material mounted at each longitudinal end thereof to a respective one of the horizontal ends of the horizontal member and slackly hanging between the ends thereof, wherein the safety line provides for connecting a safety harness worn by a worker thereto.

In accordance with an aspect of the present disclosure, there is provided a kit for a scaffolding structure comprising: at least a pair of spaced apart vertical structures upstanding from respective bases; at least one horizontal member for being mounted at each horizontal end thereof to a respective one of the pair of vertical structures; and a safety line comprising resilient material for being mounted at each longitudinal end thereof to a respective one of the horizontal ends of the horizontal member and slackly hanging between the ends thereof, wherein the safety line provides for connecting a safety harness worn by a worker thereto.

In accordance with an aspect of the present disclosure, there is provided a kit for a scaffolding structure comprising: at least a pair of spaced apart vertical structures upstanding from respective bases; at least one horizontal member for being mounted at each horizontal end thereof to a respective one of the pair of vertical structures; and a safety line comprising resilient material mounted at each longitudinal end thereof to a respective one of the horizontal ends of the horizontal member and slackly hanging between the ends thereof, wherein the safety line provides for connecting a safety harness worn by a worker thereto.

In accordance with an aspect of the present disclosure, there is provided a method of providing scaffolding structure comprising, the method comprising: providing at least a pair of spaced apart vertical structures upstanding from respective bases; mounting at least one horizontal member at each horizontal end thereof to a respective one of the pair of vertical structures; providing a safety line comprising resilient material; mounting the safety line at each longitudinal end thereof to a respective one of the horizontal ends of the horizontal member so that the safety line slackly hangs between the ends thereof, wherein the safety line provides for connecting a safety harness worn by a worker thereto.

Other objects, advantages and features of the present disclosure will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a perspective view of a scaffolding structure in accordance with a non-limiting illustrative embodiment of the present disclosure;

FIG. 2 is a perspective view of a scaffolding structure similar to the structure shown in FIG. 1;

FIG. 3 is a perspective view of a scaffolding structure similar to the structure shown in FIG. 2;

FIGS. 4A and 4B are respective perspective and enlarged views of portions A and B of FIG. 3, respectively;

FIG. 5A is a perspective view of the horizontal member or scaffolding safety device of the scaffolding structures of FIG. 1, 2 or 3, in an assembled position in accordance with a non-limiting illustrative embodiment of the present disclosure;

FIG. 5B is a front perspective view of the horizontal member or scaffolding safety device of the scaffolding structures of FIG. 1, 2 or 3, in an assembled position in accordance with a non-limiting illustrative embodiment of the present disclosure;

FIG. 5C is a perspective view of the horizontal member or scaffolding safety device of the scaffolding structures of FIG. 1, 2 or 3, in a partially disassembled position in accordance with a non-limiting illustrative embodiment of the present disclosure;

FIG. 5D is a is a perspective view of the horizontal member or scaffolding safety device of the scaffolding structures of FIG. 1, 2 or 3, in a partially disassembled position in accordance with a non-limiting illustrative embodiment of the present disclosure;

FIG. 6 is a perspective view of a scaffolding structure in accordance with another non-limiting illustrative embodiment of the present disclosure;

FIG. 7 is a perspective view of a scaffolding structure in accordance with a further non-limiting illustrative embodiment of the present disclosure;

FIG. 8 is an enlarged perspective view of portion 8 in FIG. 7;

FIG. 9 is a perspective view of a scaffolding structure similar to the structure shown in FIG. 1 including a platform for a worker in accordance with a non-limiting illustrative embodiment of the present disclosure;

FIG. 10 is a perspective view the kit or assembly of FIG. 9 including a horizontal scaffolding safety device and a lanyard for a harness in accordance with a non-limiting illustrative embodiment of the present disclosure; and

FIG. 11 is a perspective view of a scaffolding structure similar to the structure shown in FIG. 1 including a platform for a worker and a vertical line.

### DETAILED DESCRIPTION

Generally stated and in accordance with a non-limiting embodiment of the present disclosure, there is provided a scaffolding safety device for being mounted to a scaffolding structure having a pair of spaced apart vertical structures and a platform horizontally extending therebetween for supporting a worker. The device comprises an elongate body, a pair of connectors and a safety line. The elongate body defines opposite longitudinal ends and each connector is positioned at or near a respective longitudinal end for being connected to a respective one of the spaced apart vertical structures thereby providing the elongate body to be horizontally disposed between the spaced apart vertical structures. The safety line comprises resilient material mounted at each longitudinal end thereof to or near a respective one of the longitudinal ends of the elongated body for horizontally and slackingly extending along a least a portion of the longitudinal length of the elongated body. The safety line provides for connecting a safety harness worn by the worker thereto. During accidental fall of the worker from the platform, the safety line provides for absorbing a force from the worker's weight via the harness.

With reference to the appended Figures, non-restrictive illustrative embodiments will be herein described so as to further exemplify the disclosure only and by no means limit the scope thereof.

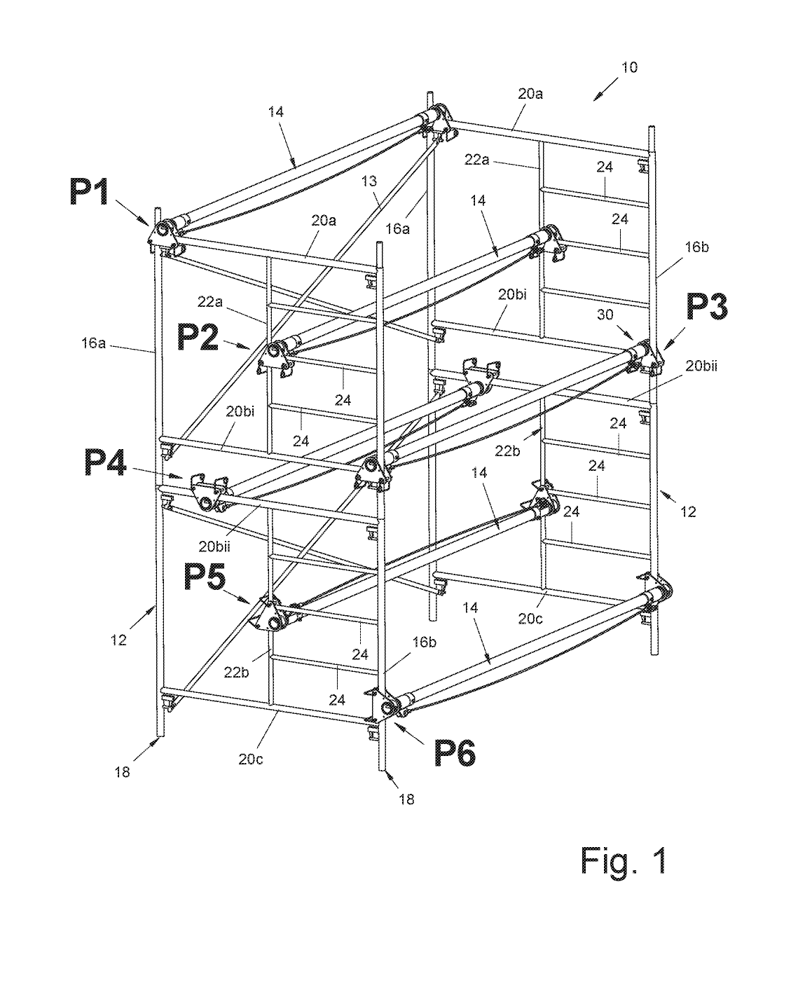

FIGS. 1, 2 and 3 show a scaffolding structure 10 comprising spaced vertical skeletal panel line structures 12 interconnected by X-like backing structures 13, that provide support and stability to the overall structure 10 as is well known in the art. As is also known in the art the scaffolding structures 10 can be vertically assembled to provide scaffolding towers of various suitable heights.

Horizontal members 14 are also interconnected at each thereof to the vertical structures 12. As will be explained below, the horizontal members 14 are scaffolding safety line assemblies, devices, members or elements.

Each vertical structure 12 defines a frame comprising a pair of vertical member 16a and 16b upstanding from respective bases 18 and interconnected by top 20a, upper median 20bi, and lower median 20bii and bottom 20c horizontal elements. Vertical median elements 22a and 22b respectively interconnect the top 20a and upper median 20bi horizontal elements and the lower median 20bi and bottom 20c horizontal members. Each vertical element 22a and 22b is interconnected to the vertical member 16b via horizontal step elements 24. Of course, the vertical structures can be provided in a variety of other suitable configurations as can be contemplated by the skilled artisan.

Of course, a variety of scaffolding vertical structures 12 and backing structures 13 can be contemplated within the scope of the present disclosure as is well understood in the art.

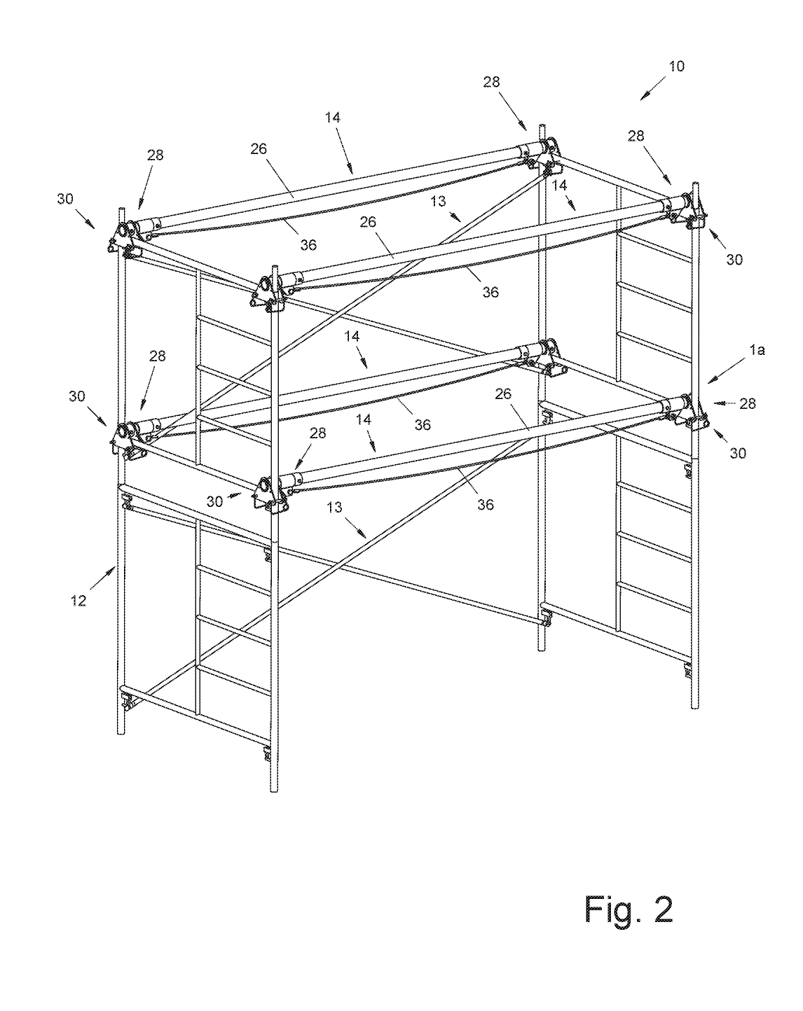

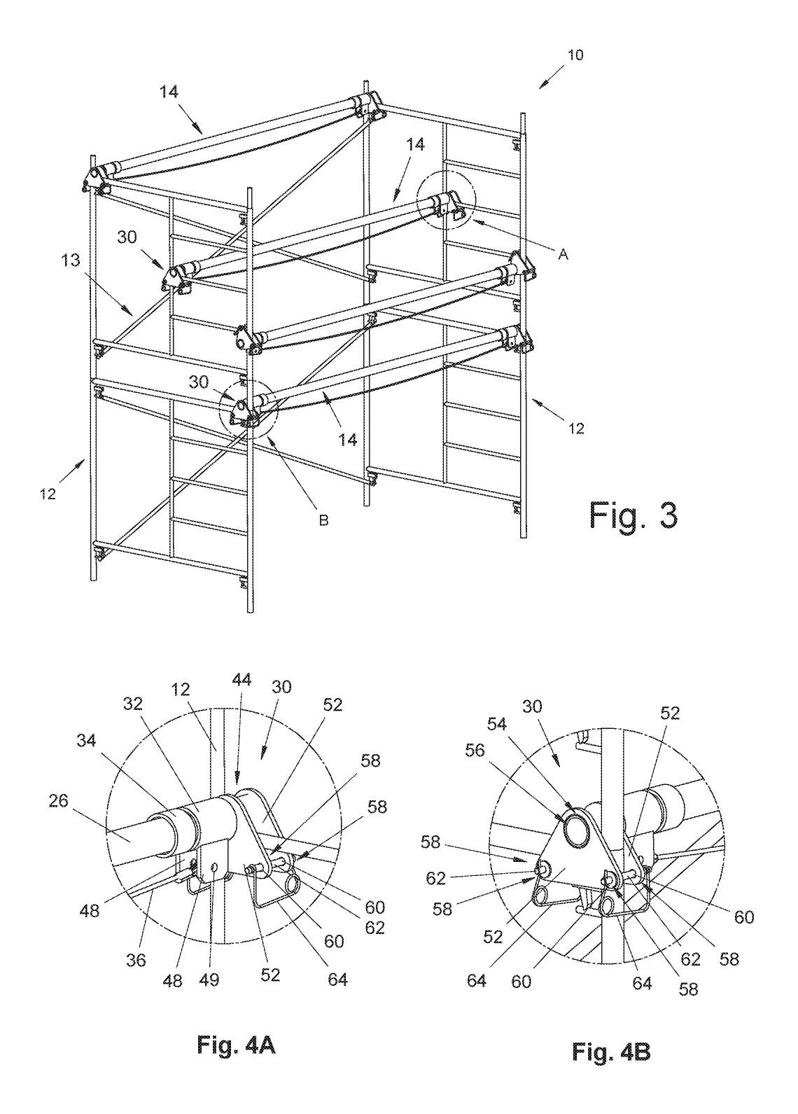

As shown in FIG. 2, the horizontal scaffolding safety line devices 14 comprise an elongated body such as rod 26 defining longitudinal ends 28. Each end 28 comprising a connector 30 for being mounted to the vertical structure 12 thus providing the rod 26 to be horizontally disposed between the spaced apart vertical structures 12. With respect to FIGS. 3 and 4A, each connector 30 includes an outer sleeve 32 mounted to an inner sleeve 34 secured to the rod 26.

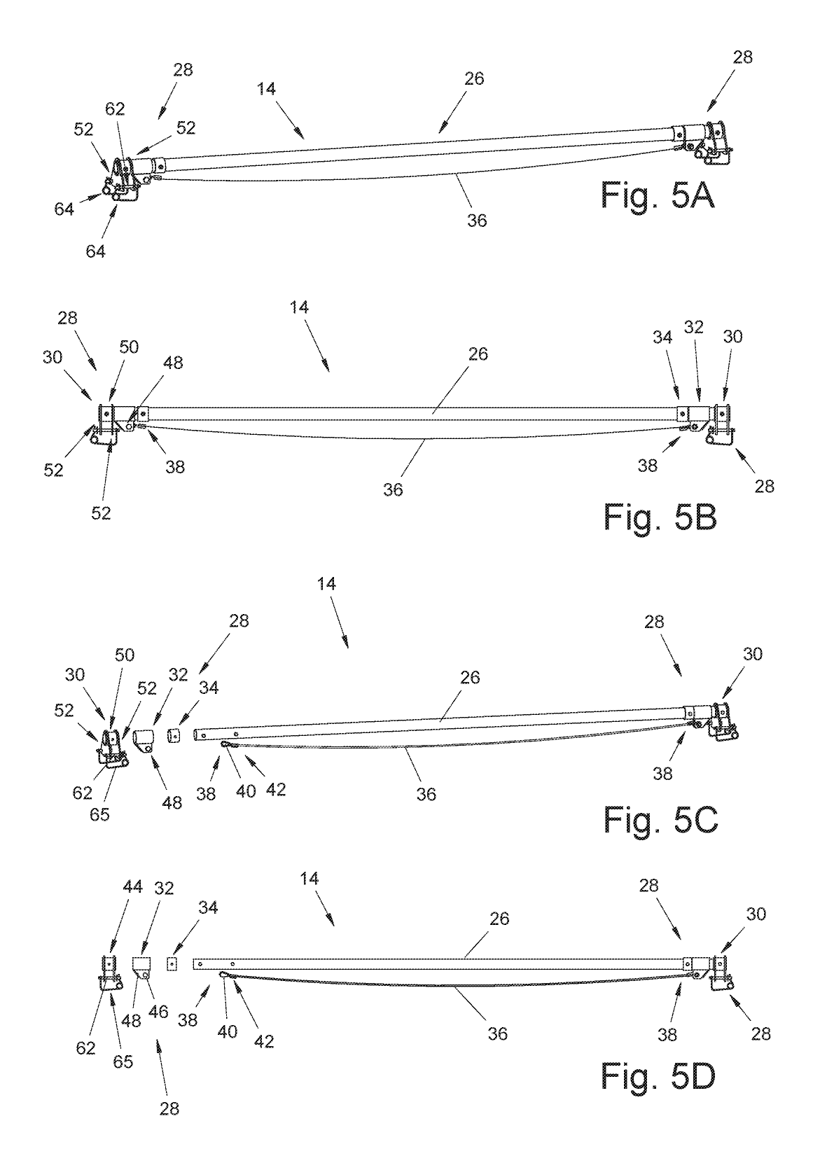

Referring particularly to FIGS. 2 and 5A to 5D, the scaffolding safety line devices 14 include a safety line 36 such as a wire made of resilient material is mounted to the rod 26. As better shown in FIGS. 5B, 5C and 5D, the safety line 36 defines longitudinal ends 38 forming loops 40 as well as adjusters 42 to loosen or tighten the loop 40. With reference to FIGS. 4A, 5C and 5D, each loop 40 is mounted to a support 46 interposed within a bracket 48 extending from the outer sleeve 32.

The support 46 is a small rod mounted at each end to a bracket 48 via apertures 49. As such, the safety line 36 is mounted at each longitudinal end 38 thereof to or near a respective one of the longitudinal ends (28) of the rod 26 for horizontally and slackingly extending along a least a portion of the longitudinal length of the rod 26.

Turning now particularly to FIGS. 4A, 4B, and 5A to 5D, the connector 30 includes a main part 44 with a sleeve 50 extending therefrom and being mounted to the outer sleeve 32. The main part 44 includes a pair of spaced apart triangular-shaped bracket plates 52 adjustably mounted to the sleeve 50. The brackets 52 define a top angle portion 54 having an aperture 56 for receiving the sleeve 50. The brackets 52 define bottom lateral angle portions 58 having apertures 60 for receiving clamp rods 62 (see FIGS. 4A, 4B, 5C and 5D) between two interfacing and spaced portions 58. Each end of the clamping rod 62 is fastened to the a respective plate portion 58 and extends out of aperture 60; the foregoing outwardly extending ends of the clamp rod are interconnected via a spring element 64. As such, when mounting the connectors 30 to the vertical structures 12, the sleeve 50 rests on one or more vertical structure 12 element (e.g. 16a, 16b, 20a, 20bi, 20bii 20c, 22a, 22b and 24). The brackets 52 and more specifically their interfacing clamps 58 therebetween also rests one or more of the aforementioned vertical structure elements. The brackets 52 are rotatable in order to conveniently position them when clamping a portion of the vertical structure as shown in the various clamping positions P1, P2, P3, P4, P5 and P6 of FIG. 1. The spring element 64 may also act as an adjustable tightener providing for securing the clamping rods 62 to their respective bracket plates 52.

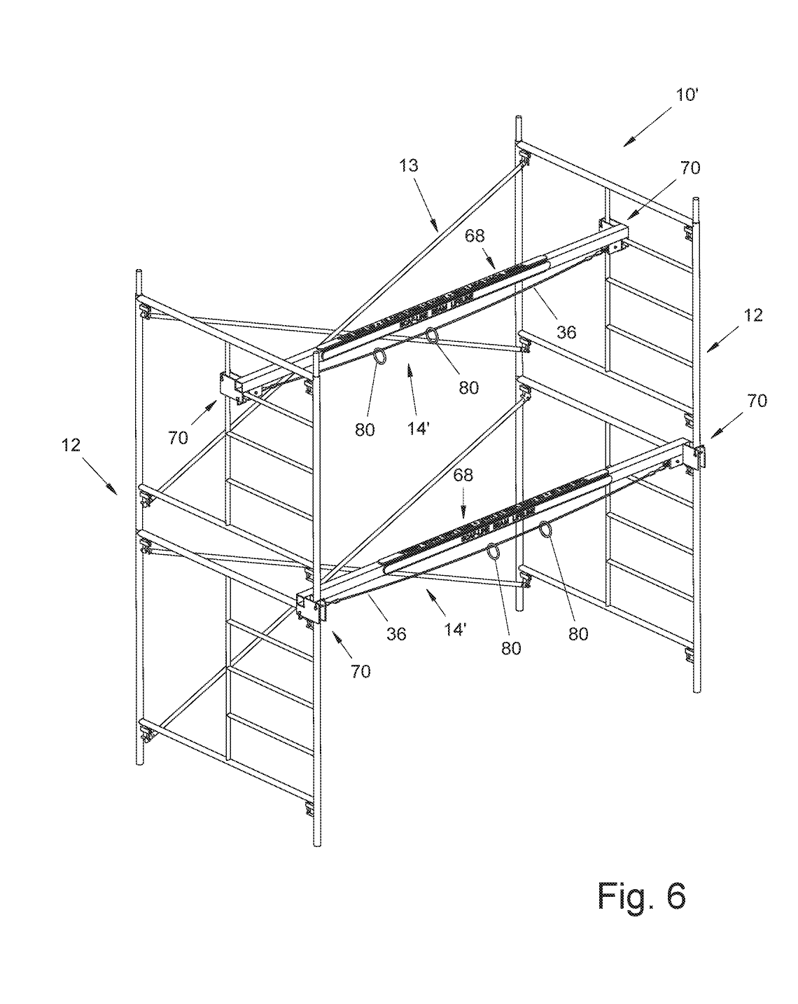

FIG. 6 shows a scaffolding structure 10′ that is similar to structure 10 as such, structure 10′ will not be described in detail for concision purposes only, yet reference numerals on FIG. 6 refer to like elements described for structure 10 with the main difference being the horizontal member or device 14′. The horizontal I member or device 14′ comprises a square rod body 68 that is adjustable in length and square end connectors 70.

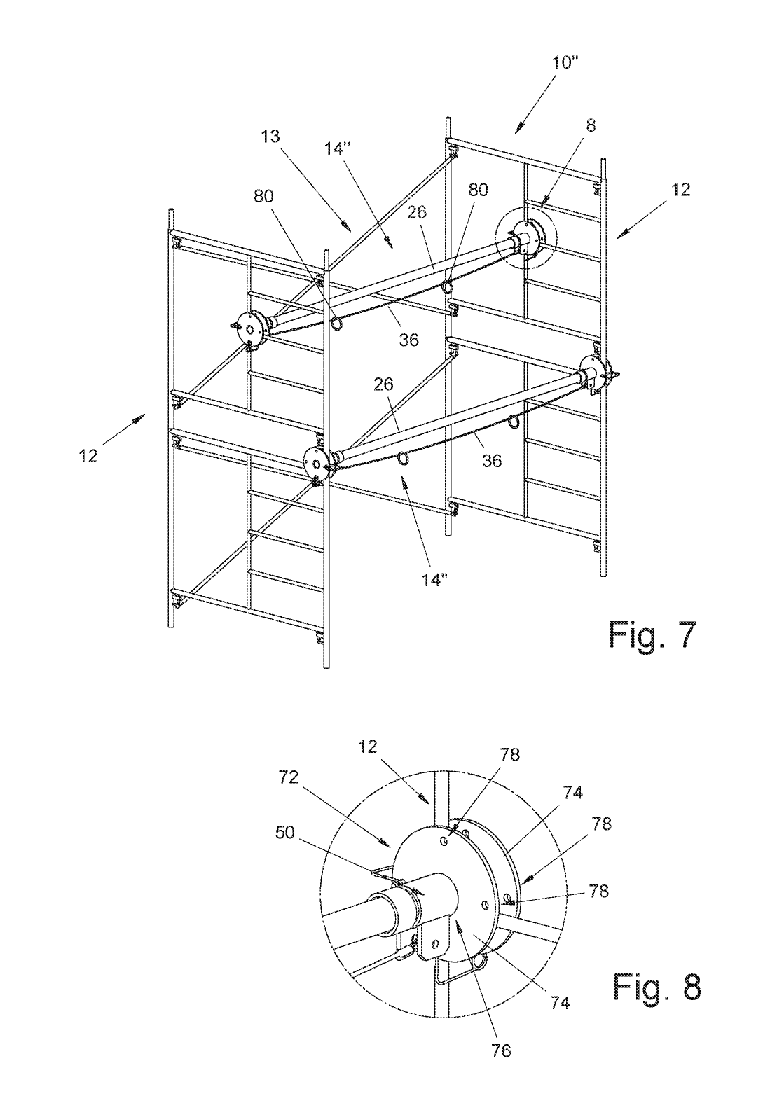

FIG. 7 shows a scaffolding structure 10″ that is similar to structures 10 and 10′ as such, structure 10″ will not be described in detail for concision purposes only, yet reference numerals on FIG. 7 refer to like elements described for structure 10 with the main difference being the horizontal member or device 14″. The horizontal member or device 14″ comprises the rod 26 and a pair of circular end connector 72. As better shown in FIG. 8, the circular end connectors 72 comprise interfacing circular bracket plates 74 mounted to the sleeve 50 about their respective central openings 76 and include peripheral apertures 78 for receiving clamping rods.

As shown in FIGS. 6 and 7, loops 80 can be mounted to the safety line 36 for connecting the straps of a worker's safety harness thereto. Of course, the worker's safety harness can be mounted directly to the safety line 36.

As shown throughout the Figures, the safety line 36 slackingly hangs between its ends 38 yet provides sufficient tension for safety usage as described herein.

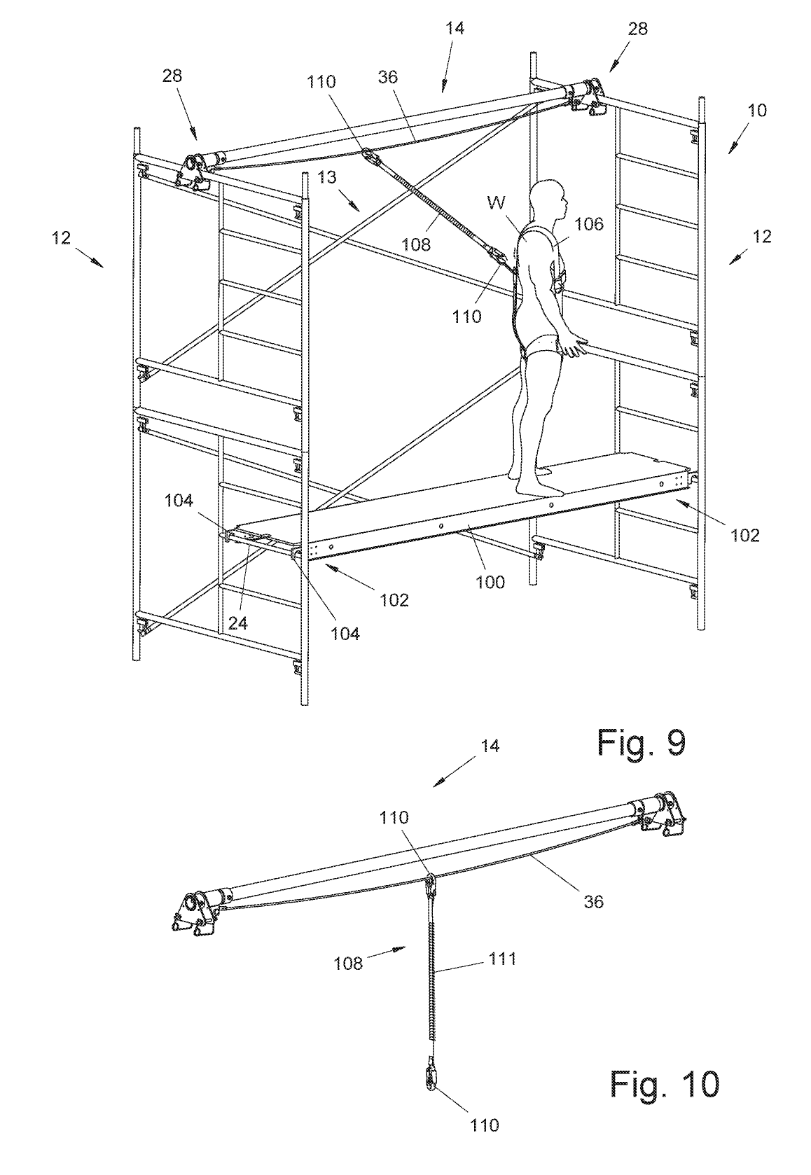

Turning now to FIG. 9, there is shown a scaffolding structure 10 as described in FIGS. 1 to 5D including a pair of opposite lateral vertical structures 12 interconnected by a backing 13 structure. The horizontal member or scaffolding safety line device 14 is mounted at each end 28 to the opposite vertical structures 12. A platform 100 is mounted at each end 102 therefor by way of hooks 104 on respective step elements 24 of the structures 12 allowing a worker W to stand thereon. The worker W is shown wearing a harness 106 and a rope or lanyard 108 is mounted at one end thereof to the harness 106 and at the other end thereof to the safety line 36 of the device 14. The lanyard 108 includes snap hooks 110 at each end thereof for being respectively clipped to the harness 106 and the safety line 36. FIG. 10 shows an assembly or kit including the device 14 and the lanyard 108 mounted thereto. The lanyard 108 may include an absorbing body 111 made of a variety of flexible and resilient materials as can be contemplated by the skilled artisan.

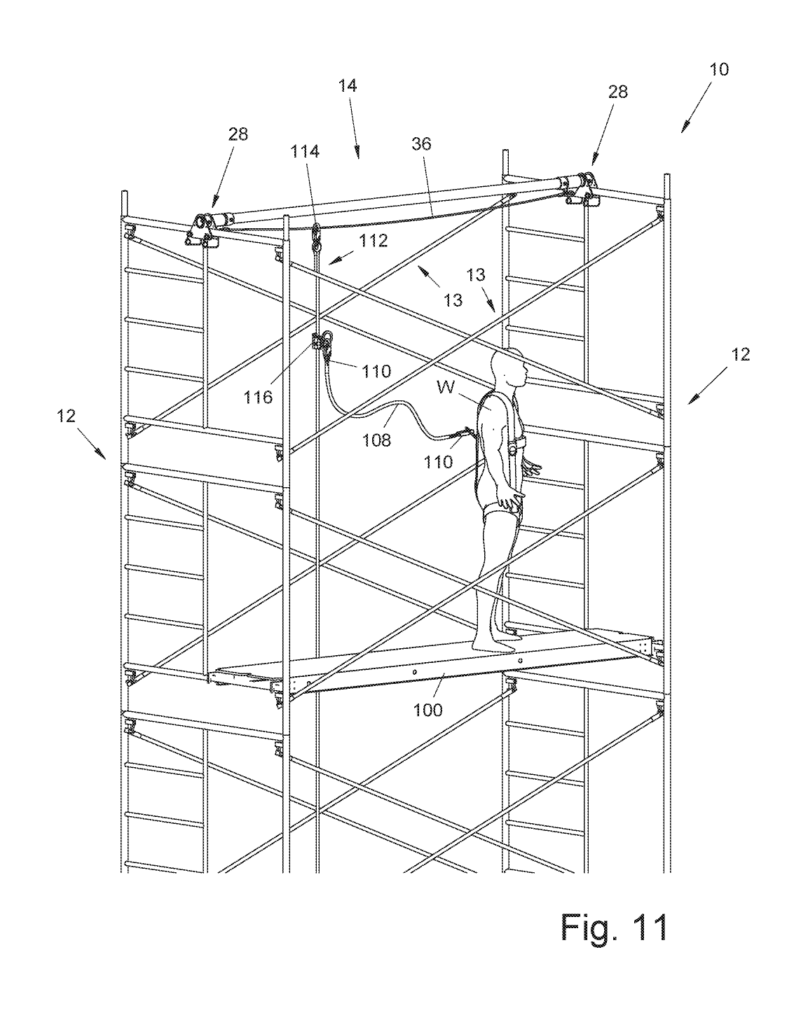

Turning now to FIG. 11, there is shown a scaffolding structures 10 providing a scaffolding tower with a platform 100 mounted thereto and a worker W standing thereon. The structures 10 including a pair of opposite lateral vertical structures 12 interconnected by front and rear supports 13 (i.e. backing). The device 14 is mounted to the structure 10 and a vertical line 112 is connected to the safety line 36 of the device 14. The worker W is wearing a harness 106 and a lanyard 108 is mounted at one end via one snap hook 110 to the harness 106 and at the other end thereof to the vertical line 112 via an opposite snap hook 110. The vertical line 112 includes a snap hook 114 at one longitudinal end thereof for being connected to the safety and its other longitudinal end (not shown) may be a free end providing the vertical line 112 to be freely suspended from the safety line 36. Alternatively, this other end of the vertical line 112 may be loosely tied to at the ground level. The vertical line 112 includes a rope grab 116 removably mounted thereto and that is slidably adjusted along the length thereof so as to be conveniently positioned along the height of the vertical line 112 for the snap hook 110 of the lanyard 108 to be connected thereto.

In case of an accidental fall, the force from the worker's weight is absorbed via their harness, the harness and lanyard, or the harness, lanyard and vertical line along the length of the safety line 36 and residually distributed to the ends 28 (via wire ends 38) which are anchored or clamped to the vertical structures 12. The tension, the slack and the material of the safety line 36 provide for absorbing most of this force caused by an accidental fall. The safety line ends 38 also absorb a residual force prior to distributing a still residual force to the ends 26 of the horizontal member 14. The rod body 26 also assists in absorbing any further residual force. The foregoing greatly limits the pressure placed on ends 28 and on the vertical structure 12. As such, the safety wire provides enough strength for preventing the worker from hitting the ground and from compromising the integrity of the scaffolding structure 10 (or 10′, or 10″) during an accidental fall.

The safety line for example only and without limitation thereto can be provided in a variety of resilient and deformable materials.

The elongate bodies or rods of the scaffolding safety devices (horizontal members) can be adjustable so as to be selectively and horizontally lengthened or shortened. As such, the horizontal members 14, 14′ or 14″ are assemblies and provided with extendible/retractable elements such as telescoping members or foldable members and the like. In another embodiment, these assemblies 14, 14′ or 14″ can also be modular and thus be provided with sub-elements that are added together for greater length or removed one at a time to be shortened. In an embodiment, these attachable/detachable sub-elements are shorter rods with clamps, hooks, bolts and the like at each longitudinal end therefor for being selectively attached to like shorter rods or selectively detached therefrom.

Of course, the scaffolding safety devices described herein can be provided in the form of a kit for assembly prior to use.

### EXAMPLE

The following is non-limiting example, provided to further exemplify the disclosure and by no means, limit the scope thereof.

### Example A

In a drop test on standard 10′ wide×5′ deep scaffold, a 250 lbs mass of loosely interlinked blocks on a non-retractable polyester strap connected to the safety line 36 was dropped. The test demonstrated that the safety line 36 prevented the mass from hitting the ground and the fall did not compromise the integrity of the standard scaffold.

It should be noted that the various components and features of the embodiments described above, whether illustrated or not, can be combined in a variety of ways so as to provide still other embodiments within the scope of claims. As such, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been described hereinabove by way of embodiments thereof, it can be modified, without departing from the spirit, scope and nature of the invention as defined herein and in the appended claims.

What is claimed is:

1. A scaffolding safety device for being mounted to a scaffolding structure having a pair of spaced apart vertical structures and a platform horizontally extending therebetween for supporting a worker, the device comprising:
an elongate body defining opposite longitudinal ends;
a pair of connectors, each connector positioned at or near a respective longitudinal end for being connected to a respective one of the spaced apart vertical structures thereby providing the elongate body to be horizontally disposed between the spaced apart vertical structures;
a safety line comprising resilient material mounted at each longitudinal end thereof to or near a respective one of the longitudinal ends of the elongated body for horizontally and slackingly extending along a least a portion of the longitudinal length of the elongated body, the safety line providing for connecting a safety harness worn by the worker thereto,
wherein during accidental fall of the worker from the platform, the safety line provides for absorbing a force from the worker's weight via the harness.

2. A device according to claim 1, wherein each of the connectors is clamped to a portion of a respective one of the spaced apart vertical structures.

3. A device according to claim 1, wherein the safety line comprises a wire.

4. A device according to claim 1, wherein the safety line comprises a wire anchored at each end to the elongate body.

5. A device according to claim 1, wherein the horizontal length of the elongate body is selectively adjustable.

6. A device according to claim 1, wherein each of the connectors is rotatable so as for being selectively positioned on a given portion of the vertical structure.

7. A device according to claim 1, wherein the safety line comprises at least one loop mounted thereto for being connected to the safety harness.

8. A device according to claim 1, wherein the safety harness is connectable to the safety line via a lanyard connectable thereto.

9. A device according to claim 8, wherein the lanyard is connectable to the safety line via vertical line connectable thereto.

10. A scaffolding safety kit for being mounted to a scaffolding structure having a pair of spaced apart vertical structures and a platform horizontally extending therebetween for supporting a worker, the kit comprising:
an elongate body defining opposite longitudinal ends;
a pair of connectors for being positioned at or near a respective longitudinal end for being connected to a respective one of the spaced apart vertical structures thereby providing the elongate body to be horizontally disposed between the spaced apart vertical structures;
a safety line comprising resilient material for being mounted at each longitudinal end thereof to or near a respective one of the longitudinal ends of the elongated body for horizontally and slackingly extending along a least a portion of the longitudinal length of the elongated body, the safety line providing for connecting a safety harness worn by the worker thereto,
wherein during accidental fall of the worker from the platform, the safety line provides for absorbing a force from the worker's weight via the harness.

11. A kit according to claim 10, further comprising the safety harness.

12. A kit according to claim 10, further comprising a lanyard for being connected to the safety harness and the safety line.

13. A kit according to claim 10, further comprising a vertical safety line for being connected to the safety harness and the safety line.

14. A scaffolding structure assembly comprising:
at least a pair of spaced apart vertical structures;
at least one platform for being mounted at each end thereof to a respective one spaced apart vertical structures thereby horizontally extending therebetween for supporting a worker; and
the scaffolding safety device according to claim 1.

15. The scaffolding structure assembly according to claim 14, further comprising a rear support for interconnecting the spaced apart vertical structures.

16. The scaffolding structure assembly according to claim 14, further comprising a front support for interconnecting the spaced apart vertical structures.

17. The scaffolding structure assembly according to claim 14, further comprising a vertical line for being suspended from the safety line.

18. A scaffolding structure comprising:
at least a pair of spaced apart vertical structures;
at least one platform mounted at each end thereof to a respective one of the spaced apart vertical structures thereby horizontally extending therebetween for supporting a worker; and
the scaffolding safety device according to claim 1.

19. A scaffolding structure according to claim 18, wherein the spaced apart vertical structures are interconnected by a support selected from the group consisting of: a front support, a rear support and a combination thereof.

20. A method of providing a scaffolding structure comprising:
providing at least a pair of spaced apart vertical structures;
mounting at least one platform at each end thereof to a respective one of the spaced apart vertical structures thereby horizontally extending therebetween for supporting a worker; and
mounting the scaffolding safety device according to claim 1 to the pair of spaced apart vertical structures.
